(19) United States
(12) Patent Application Publication
(10) Pub. No.: US 2024/0258748 A1
(43) Pub. Date: Aug. 1, 2024

(54) CONNECTOR

(71) Applicant: Yazaki Corporation, Tokyo (JP)

(72) Inventors: Shotarou SHIBATA, Makinohara-shi (JP); Hayato IIZUKA, Makinohara-shi (JP); Hideto KUMAKURA, Makinohara-shi (JP); Takumi OKI, Makinohara-shi (JP); Takuya OHASHI, Fujieda-shi (JP)

(73) Assignee: Yazaki Corporation, Tokyo (JP)

(21) Appl. No.: 18/422,803

(22) Filed: Jan. 25, 2024

(30) Foreign Application Priority Data
Feb. 1, 2023 (JP) 2023-014080

(51) Int. Cl. H01R 13/6581; H01R 13/405

(52) U.S. Cl. CPC H01R 13/6581; H01R 13/405; H01R 2201/26

(57) ABSTRACT

A connector configured to be connected to an object includes: an electric wire with a terminal; a housing; a shield shell; and a fixing element. The fixing element is fixed to the shield shell and protrudes toward a front side. In a state of the fixing element being inserted in a guiding section in the object, displacement of the fixing element along an axial direction is limited. An end of the fixing element oriented toward the front side is located further toward the front side than ends of the housing and the shield shell oriented toward the front side.

### BACKGROUND OF THE INVENTION

### Technical Field

The present invention relates to a connector.

### Background Art

A connector is known which includes a shield shell for accommodating a housing of a terminal (see e.g. Patent Document 1). According to Patent Document 1, the connector is configured such that the shield shell includes a lower shell and an upper shell which face each other in a thickness direction of the housing. An accommodating space section is formed between the lower shell and upper shell, wherein the accommodating space section accommodates the housing.

### CITATION LIST

### Patent Literature

Patent Document 1: JP 2019-110042 A

### SUMMARY OF THE INVENTION

Such a type of connector is configured to be connected and fixed by means of a connection element e.g. to a casing of a device as an object intended to be connected to the connector. However, for connecting and fixing the connector, the housing needs to be e.g. held by hand of an operator in order to prevent offset of a position of the connector, which makes the operation difficult.

An objective of the present invention is to obtain a connector which improves attachability of the connector to an object.

In order to achieve the above-mentioned objective, a connector configured to be connected to an object includes: an electric wire with a terminal; a housing configured to accommodate the terminal therein; a shield shell surrounding the housing; and a fixing element fixed to the shield shell and protruding toward one side along a direction of facing, wherein the housing is configured to face the object in the direction of facing, wherein the fixing element is provided so as to be insertable into a guiding section in the object, the guiding section being opened toward an opposite side along the direction of facing, wherein displacement of the fixing element along a direction of intersection is configured to be limited in a state of the fixing element being inserted in the guiding section, and the direction of intersection intersects the direction of facing, and wherein an end of the fixing element oriented toward the one side along the direction of facing is located further toward the one side along the direction of facing than ends of the housing and the shield shell oriented toward the one side along the direction of facing.

The present invention enables a connector to be obtained which improves attachability of the connector to an object.

### BRIEF DESCRIPTION OF THE DRAWINGS

FIG. 1 shows a perspective view of a connector according to an embodiment of the present invention;

FIG. 2 shows a side view of the connector;

FIG. 3 shows a sectional view of the connector before being connected to an object;

FIG. 4 shows a sectional view of the connector after being completely connected to the object;

FIG. 5 shows a sectional view of the connector in a state where its displacement is limited by a fixing element; and

FIG. 6 shows an enlarged view of a region A in FIG. 5.

### DETAILED DESCRIPTION OF THE PREFERRED EMBODIMENTS

Hereinafter, a connector 1 will be described. A connector 1 according to the present embodiment is configured e.g. as a female connector which forms part of a wire harness, wherein the wire harness is configured to connect a power supply to a device (hereinafter referred to as “object 2”) such as an inverter for installation to a hybrid vehicle. The connector 1 includes electric wires 10 with terminals, a housing 20, a shield shell 30, and fixing elements 40. It is to be noted that in the figures, arrows X, Y and Z extend orthogonally to each other. Arrow X indicates a direction in which the object 2 and the housing 20 face each other. In the present embodiment, this direction shall be referred to as “front-rear direction X”, wherein one side and an opposite side along the front-rear direction X shall be referred to as “front side X1” and “rear side X2”, respectively. Arrow Y indicates a width direction of the housing 20. This width direction shall be referred to as “right-left direction Y”, wherein one side and an opposite side along the right-left direction Y shall be referred to as “left side Y1” and “right side Y2”, respectively. Arrow Z indicates an axial direction of electric wires 11 which form part of the respective electric wires 10 with the terminals. This axial direction shall be referred to as “axial direction Z”, wherein one side and an opposite side along the axial direction Z shall be referred to as “one end side Z1” and “opposite end side Z2”, respectively. The above definitions are not necessarily intended for limiting an orientation of the connector 1 during its actual use, but merely intended for better understanding.

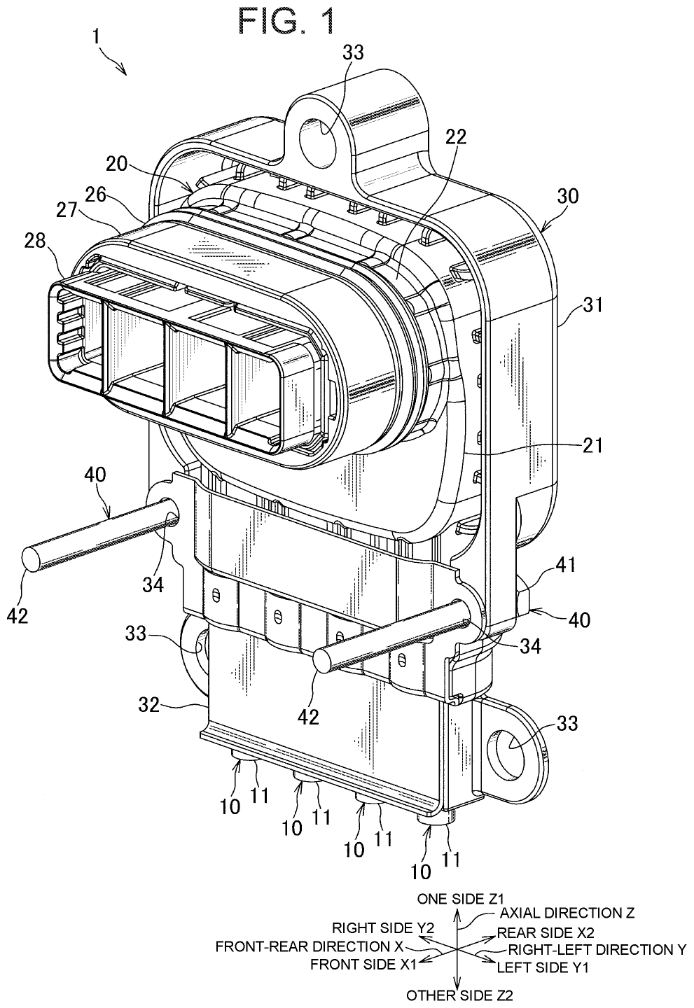

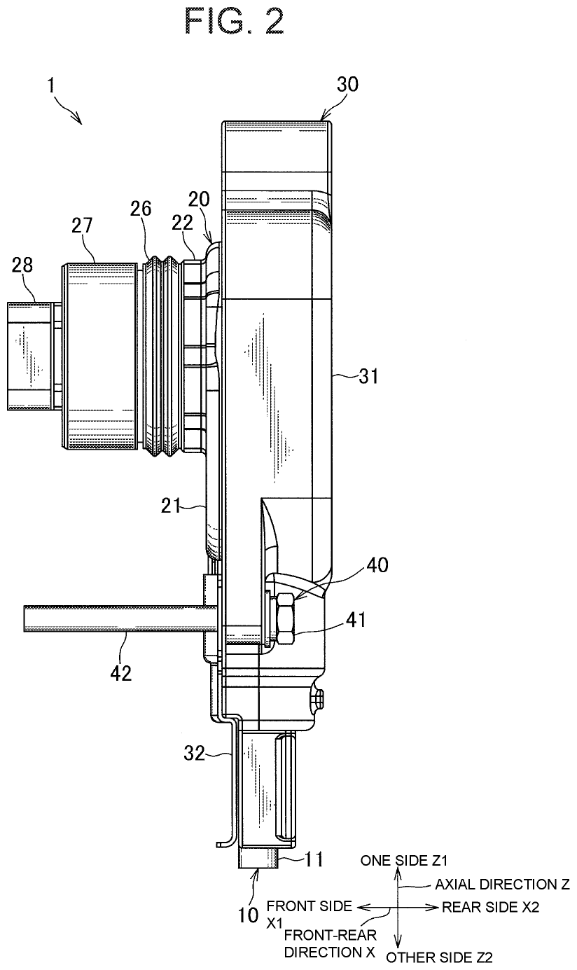

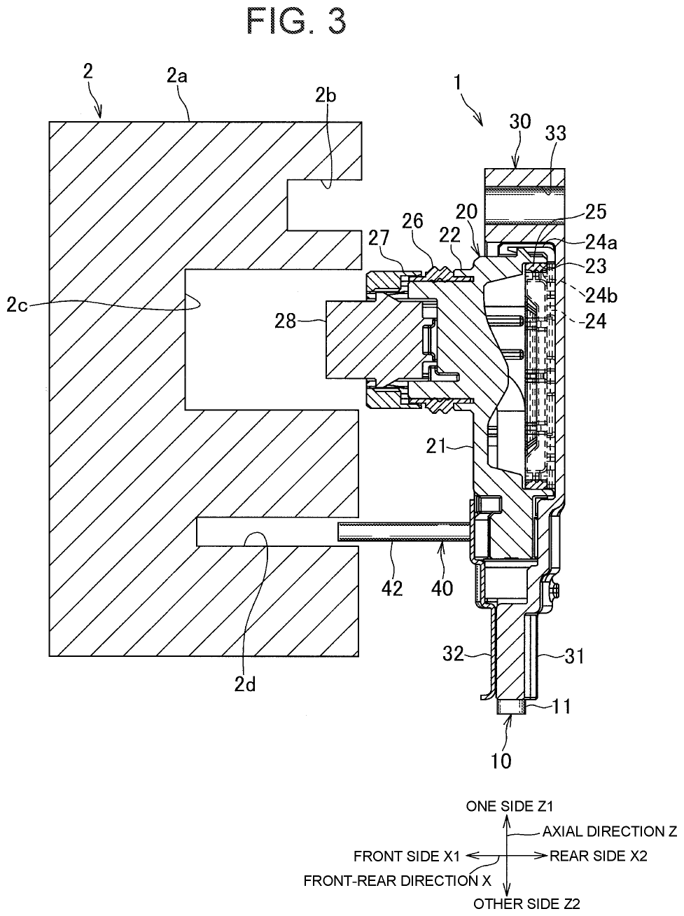

Each of the electric wires 10 with the terminals includes the electric wire 11 and the terminal (not shown), wherein the terminal is connected to a side of the electric wire 11 oriented toward the one end side Z1. The electric wire 11 is a shielded electric wire for connecting the object 2 to another equipment. In the present embodiment, four electric wires 11 are provided and adjacent to each other in the right-left direction Y, as shown in FIG. 1. The terminal which is not shown is connected to a side of the electric wire 10 oriented toward the one end side Z1, wherein the terminal extends toward the front side X1. The housing 20 is an element made of a resin which is configured to accommodate the sides of the electric wires 10 with the terminals oriented toward the one end side Z1. As shown in FIG. 2, the housing 20 includes a main body 21 and a connection portion 22 and is formed in an L-shaped tubular shape, the main body 21 extending along the axial direction Z, wherein the connection portion 22 is continuous with an end of the main body 21 oriented toward the one end side Z1 and extends toward the front side X1. The main body 21 is formed in a rectangular box shape extending along the right-left direction Y and the axial direction Z, and surrounds the electric wires 11 which are arranged in the right-left direction Y. An operation hole 23 is provided in a face of the main body 21 toward the rear side X2, wherein the operation hole 23 extends through it in the front-rear direction X, as shown in FIG. 3.

The operation hole 23 is configured to allow access the inside of the main body 21 from the outside. A cap 24 is placed on an opening edge of the operation hole 23 to open and close the operation hole 23. The cap 24 is a lid member made of an electrically conductive shield material, and includes a tubular outer wall 24a and a tubular inner wall 24b, wherein the tubular outer wall 24a covers an outer surface of the opening edge of the operation hole 23, and the inner wall 24b covers an inner surface of the opening edge of the operation hole 23. A first seal element 25 extends along an entire circumference between the inner wall 24b and the inner surface of the opening edge of the operation hole 23. The first seal element 25 is configured e.g. as a packing, and prevents e.g. a liquid and/or solid substance from entering the inside of the main body 21. The connection portion 22 is configured to accommodate the terminals connected to the electric wires 11 and to accommodate partner terminals (not shown) of the object 2 for connection to the terminals. The connection portion 22 is formed in a cylindrical shape extending toward the front side X1 from the main body 21.

As shown in FIG. 1, a second seal element 26 is placed on a portion of an outer circumferential surface of the connection portion 22 oriented toward the rear side X2, wherein the second seal element 26 covers the portion oriented toward the rear side X2 along its entire circumference. The second seal element 26 is configured e.g. as a packing and interposed between the housing 20 and an accommodating section 2c of the object 2 (which will be described below), and prevents e.g. a liquid and/or solid substance from entering the object 2. A tubular detent 27 for preventing removal is placed at on a portion of the outer circumferential surface of the connection portion 22 oriented toward the front side X1, wherein the detent 27 covers the portion oriented toward the front side X1 along its entire circumference and protrudes toward the front side X1. The detent 27 is configured to come into contact with an end of the second seal element 26 oriented toward the front side X1 to prevent the second seal element 26 from being removed toward the front side X1. A terminal accommodating section 28 having a box shape is inserted and fixed inside an opening of the connection portion 22 oriented toward the front side X1. The terminal accommodating section 28 is configured to accommodate terminals. According to the present embodiment, the terminal accommodating section 28 is partitioned into four compartments in order to adapt it to the number of terminals.

The shield shell 30 is a shield element which can be connected to the above-mentioned electric wires 11 and/or cap 24 in an electrically conductive manner. The shield shell 30 covers the housing 20 to shield electromagnetic radiation which may cause e.g. noises. The shield shell 30 includes an upper shell 31 (first shell) and a lower shell 32 (second shell), wherein the upper shell 31 covers a side of the housing 20 oriented toward the rear side X2, and the lower shell 32 covers a side of the housing 20 oriented toward the front side X1. First fixing holes 33 are formed in opposite ends of the upper shell 31 in the right-left direction Y, i.e., ends of the upper shell 31 oriented toward the one end side Z1 and toward the opposite end side Z2, wherein the first fixing holes 33 extend through the upper shell 31 along the front-rear direction X. The first fixing holes 33 are configured to insert connection bolts (connection elements, not shown) therein, wherein the connector 1 is fixed to the object 2 by the connection bolts. The lower shell 32 covers a side of the connection portion 22 of the housing 20 oriented toward the opposite end side Z2. Insertion holes 34 are formed in portions of the lower shell 32 on its opposite ends in the right-left direction Y, the portions being intended to overlap with the upper shell 31, wherein the insertion holes 34 extend through the lower shell 32 along the front-rear direction X. The fixing elements 40 are inserted through the insertion holes 34, wherein the fixing elements 40 extend along the front-rear direction X.

Each of the fixing elements 40 is a bolt to be fixed to the shield shell 30. Each of the fixing elements 40 includes a head 41, a threaded portion which is continuous with the head 41 and not shown, and a guide portion 42, wherein the guide portion 42 is continuous with the threaded portion and extends through the above-mentioned insertion hole 34 to protrude toward the front side X1. The head 41 is in contact with a wall surface of the upper shell 31 oriented toward the rear side X2. For example, the threaded portion is screwed with a nut section (not shown) which is fixed via welding to a side of the lower shell 32 oriented toward the rear side X2, whereby the upper shell 31 is connected to the lower shell 32 by the threaded portion. By this screwing, the fixing elements 40 are also fixed to the shield shell 30. In addition, by the above-mentioned screwing, the upper shell 31, the housing 20 and the lower shell 32 are integral with each other, with the housing 20 being clamped between the upper shell 31 and the lower shell 32. It is to be noted that the nut sections may be also separate from the lower shell 32 and may be disposed on sides of the insertion holes 34 of the lower shell 32 oriented toward the front side X1. Each of the guide portions 42 is formed in a bar shape extending toward the front side X1, wherein the guide portion 42 is insertable toward the front side X1 into a guiding section 2d of the object 2, which will be described below. Furthermore, an end of the guide portion 42 oriented toward the front side X1 is located further toward the front side X1 than an end of the connection portion 22 oriented toward the front side X1, as shown in FIG. 2. This means that ends of the fixing elements 40 oriented toward the front side X1 are located further toward the front side X1 than ends of the housing 20 and the shield shell 30 oriented toward the front side X1.

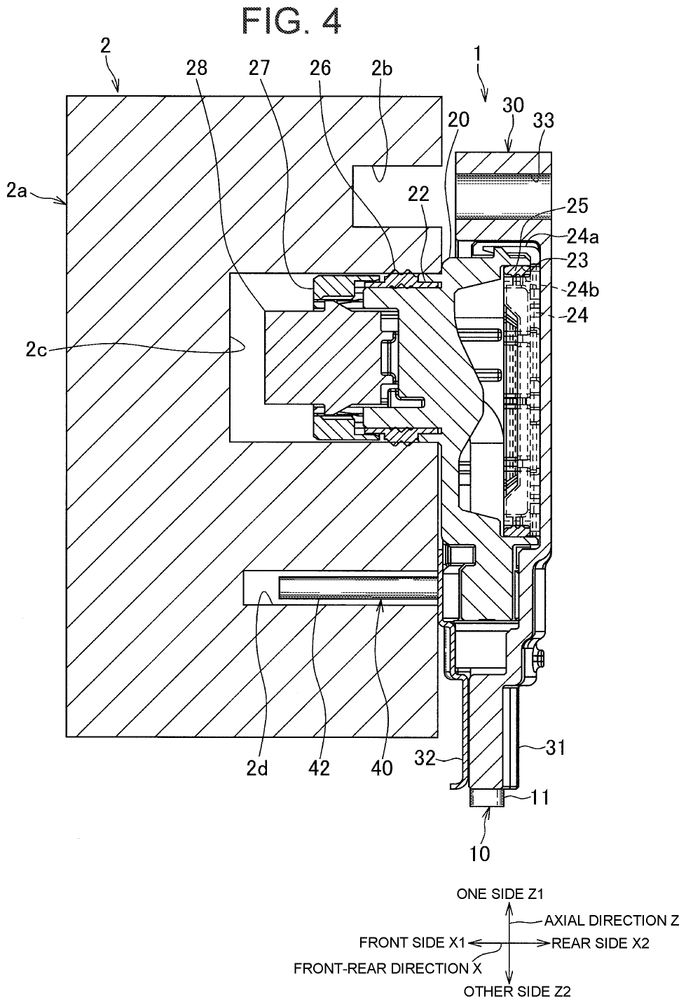

The object 2 includes a casing 2a for accommodating a device such as an inverter for installation within a vehicle, as shown in FIG. 4. Final fixing holes 2b (fixing hole), an accommodating section 2c, and the guiding sections 2d (temporary positioning holes) are formed in a wall surface of the casing 2a oriented toward the rear side X2, wherein each of the final fixing holes 2b, accommodating section 2c and guiding sections 2d are opened toward the rear side X2. The final fixing holes 2b are configured as threaded holes for screwing the respective connection bolts therewith which are inserted through the respective first fixing holes 33 in the lower shell 32 as described above, wherein each of the final fixing holes 2b is formed in a position in which the final fixing hole 2b is positioned coaxially with a corresponding first fixing hole 33. As shown in FIG. 4, the accommodating section 2c is configured for mating the connection portion 22 of the housing 20 therewith, wherein an inner wall surface of the accommodating section 2c has a shape conformed to that of an outer wall surface of the connection portion 22. The guiding sections 2d are configured as recesses for inserting the respective guide portions 42 of the fixing elements 40 therein, wherein each of the guiding sections 2d is formed in a position corresponding to a respective one of the fixing elements 40 and extends along the front-rear direction X.

Next, a method of connecting the connector 1 to the object 2. In this embodiment, the connector 1 and object 2 are moved toward each other in the front-rear direction X (predetermined direction) in order to connect them. The method of connecting the connector 1 to the object 2 includes a temporary positioning step and a final fixing step. In the temporary positioning step, the connector 1 and the object 2 are first aligned in the front-rear direction X such that the connection portion 22 face the accommodating section 2c and the guide portions 42 face the guiding sections 2d, as shown in FIG. 3. In this state, the connector 1 is then moved toward the front side X1. As shown in FIG. 3, this movement of the connector 1 initiates insertion of the ends of the guide portions 42 oriented toward the front side X1—which are located further toward the front side X1 than the connection portion 22—into the guiding sections 2d, wherein the ends of the guide portions 42 oriented toward the front side X1 are guided toward the front side X1 by inner wall surfaces of the guiding sections 2d. This enables the connector 1 to be moved toward the front side X1 while making it difficult to displace a position of the connector 1 relative to the object 2.

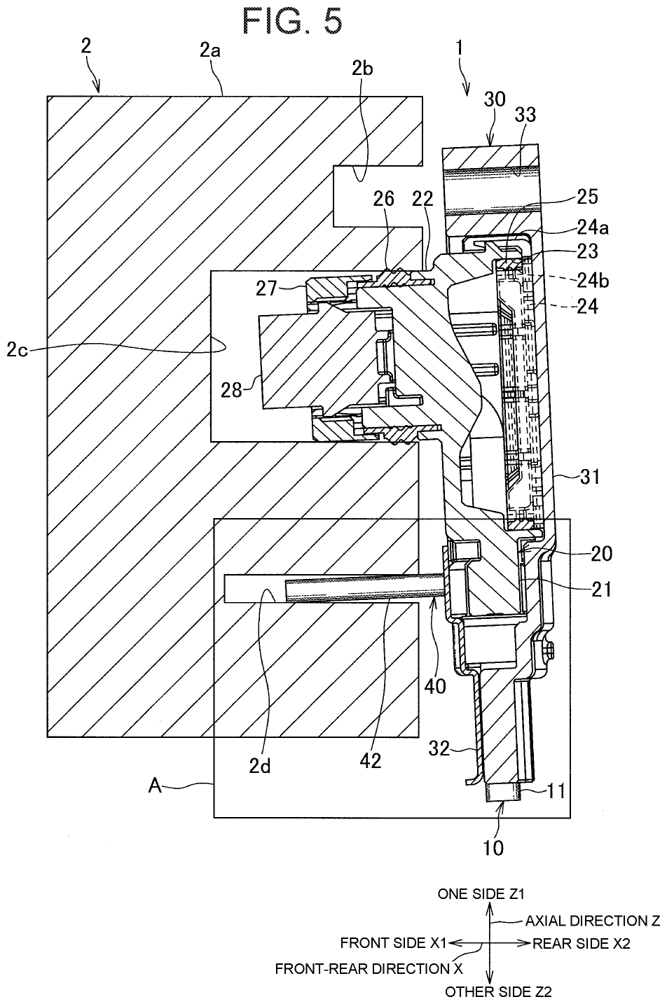

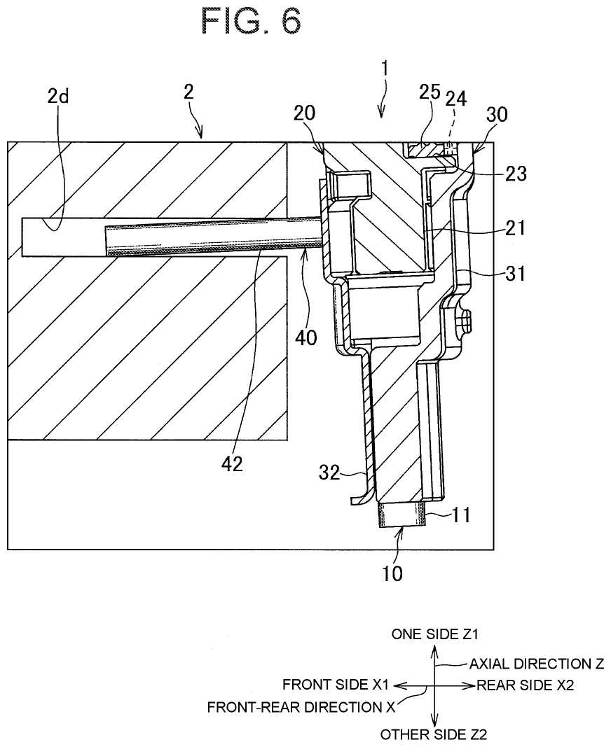

As the connector 1 is further moved, the connection portion 22 is mated with the accommodating section 2c, wherein a wall surface of the lower shell 32 oriented toward the front side X1 comes into contact with the wall surface of the casing 2a oriented toward the rear side X2, as shown in FIG. 4. In this manner, movement of the connector 1 toward the front side X1 is completed. In this state, even when displacement of the connector 1 is attempted which inclines it in the front-rear direction X, the guide portions 42 come into contact with the respective inner wall surfaces of the guiding sections 2d so that their displacement in the axial direction Z is limited, whereby displacement of the connector 1 in the front-rear direction X is limited, as shown in FIGS. 5 and 6.

Namely, the position of the connector 1 relative to the object 2 is temporarily fixed by the temporary positioning step. Next, the final fixing step is performed. In the final fixing step, the connector 1 is connected and fixed to the object 2 by means of the connection bolts (connection elements) so that the connector 1 is not displaceable relative to the object 2. Here, the connection bolts are inserted through the respective first fixing holes 33 in the upper shell 31 and screwed with the respective final fixing holes 2b in the object 2. It is to be noted that at this time, the connector 1 has been temporarily positioned by the temporary positioning step, which enables the final fixing step to be easily performed, for example without requiring adjustment of inclination of the connector 1 by an operator or holding the connector 1 by hand of an operator.

As described above, the connector 1 according to the present embodiment is configured to be connected to the object 2 and includes the electric wires 10 with terminals, housing 20, shield shell 30 and fixing elements 40. The fixing elements 40 are fixed to the shield shell 30 and protrude toward the front side X1 (one side along the direction of facing). In the state of the fixing elements 40 being inserted in the guiding sections 2d of the object 2, displacement of the fixing elements 40 is limited along the axial direction Z (direction of intersection). The ends of the fixing elements 40 oriented toward the front side X1 are located further toward the front side X1 than the ends of the housing 20 and the shield shell 30 oriented toward the front side X1.

In this manner, the displacement of the fixing elements 40 along the axial direction Z can be limited by inserting, into the guiding sections 2d in the object 2, the fixing elements 40 fixed to the shield shell 30. This enables displacement of the housing 20 and the shield shell 30 in the front-rear direction X to be limited via the fixing elements 40. Further, it is then possible to connect the connector 1 to the object 2 by using elements such as connection bolts while displacement of the housing 20 and the shield shell 30 is limited in the front-rear direction X. Thus, for connecting and fixing the connector 1, it is not necessary e.g. to hold the housing 20 by hand of the operator in order to prevent offset of the position of the connector 1. Furthermore, according to the above-described embodiment, for connecting and fixing the connector 1 to the object 2, the guide portions 42 of the fixing elements 40 are inserted into the respective guiding sections 2d and guided by the guiding sections 2d before mating the connection portion 22 with the accommodating section 2c. This makes it difficult to change the position and/or pose of the connector 1 relative to the object 2, and it is possible to move the connector 1 toward the object 2 in this state. This facilitates installation of the connector 1 to a portion of the object 2 which is intended to be connected to the connector 1. This enables a connector 1 to be obtained which improves attachability of the connector 1 to the object 2.

According to the above-described embodiment, the fixing elements 40 are configured as bolts to be fixed to the shield shell 30. Therefore, for limiting displacement of the connector 1 relative to the object 2, it is not necessary to change a shape and/or size of the housing 20 and/or shield shell 30 themselves. This enables increase in size and/or complexity of components of the connector 1 to be suppressed.

Furthermore, the shield shell 30 includes the upper shell 31 and lower shell 32. Here, in a state of the fixing elements 40 being fixed to the shield shell 30, the housing 20 is clamped between the upper shell 31 and the lower shell 32 so that the upper shell 31, the housing 20 and the lower shell 32 are integral with each other. It is thus possible to stably maintain a state in which displacement of the housing 20 is difficult within the shield shell 30 and the housing 20 is integral with the shield shell 30.

In addition, the fixing elements 40 which are already fixed to the shield shell 30 are accommodated into the guiding sections 2d (temporary positioning holes) by the temporary positioning step, which enables the connector 1 to be temporarily positioned relative to the object 2. In this temporary positioned state, it is possible to connect and fix the connector 1 to the object 2 in a non-displaceable manner in the final fixing step. Thus, it may be unnecessary e.g. to hold the housing by hand of the operator for performing the final fixing step, which facilitates attachment of the connector 1 to the object 2.

Although the exemplary embodiment of the connector has been described in details with reference to the drawings, the present invention is not limited to the specific embodiment, but also includes design modifications and the like which do not depart from the sprit and core of the present invention.

### REFERENCE SIGNS LIST

1 Connector
2 Object intended to be connected to the connector 1
2d Guiding section
10 Electric wires with terminals
20 Housing
30 Shield shell
40 Fixing elements

What is claimed is:

1. A connector configured to be connected to an object, comprising:
an electric wire with a terminal;
a housing configured to accommodate the terminal therein;
a shield shell surrounding the housing; and
a fixing element fixed to the shield shell and protruding toward one side along a direction of facing, wherein the housing is configured to face the object in the direction of facing,
wherein the fixing element is provided so as to be insertable into a guiding section in the object, the guiding section being opened toward an opposite side along the direction of facing,
wherein displacement of the fixing element along a direction of intersection is configured to be limited in a state of the fixing element being inserted in the guiding section, and the direction of intersection intersects the direction of facing, and
wherein an end of the fixing element oriented toward the one side along the direction of facing is located further toward the one side along the direction of facing than ends of the housing and the shield shell oriented toward the one side along the direction of facing.

2. The connector according to claim 1,
wherein the fixing element is a bolt including a threaded portion and a guide portion, the guide portion being continuous with the threaded portion, and
wherein the guiding section is a recess in the object.

3. The connector according to claim 2,
wherein the shield shell includes a first shell and a second shell, the first shell being provided on a side of the housing oriented toward the opposite side along the direction of facing, the second shell being provided on a side of the housing oriented toward the one side along the direction of facing,
wherein in a state of the fixing element being fixed to the shield shell, the housing is configured to be clamped between the first shell and the second shell, and the first shell, the housing and the second shell are configured to be integral with each other.

4. A method of connecting a connector to an object along a predetermined direction,
wherein the connector includes an electric wire with a terminal, a housing, a shield shell and a fixing element, the housing being configured to accommodate the terminal therein and the shield shell surrounding the housing, wherein the fixing element is fixed to the shield shell and protrudes along the predetermined direction,
wherein the object includes a temporary positioning hole as a guiding section and a fixing hole, the temporary positioning hole being opened toward the connector and the fixing hole being opened toward the connector,
wherein the method comprises:
a temporary positioning step of temporarily positioning the connector relative to the object by accommodating the fixing element into the temporary positioning hole; and
subsequently, a final fixing step of finally fixing the connector to the object by means of a connection element, the connection element configured to be fixed into the fixing hole.
